(19) United States
(12) Patent Application Publication
(10) Pub. No.: US 2026/0269973 A1
(43) Pub. Date: Sep. 10, 2026

(54) AIRBORNE SYSTEM FOR COUNTERING UNMANNED AIRCRAFT

(71) Applicant: Davenport Aviation, Inc., Columbus, OH (US)

(72) Inventor: Joao Flavio Dias da Silva Simoes, Columbus, OH (US)

(21) Appl. No.: 19/162,829

(22) PCT Filed: Mar. 6, 2024
(86) PCT No.: PCT/US2024/018693

§ 371 Date: Sep. 5, 2025

Related U.S. Application Data
(60) Provisional application No. 63/488,551, filed on Mar. 6, 2023.

(51) Int. Cl. H04K 3/00; G08G 5/72

(52) U.S. Cl. CPC H04K 3/92; G08G 5/727; H04K 3/42; H04K 2203/22; H04K 2203/32

(57) ABSTRACT

Disclosed is a system for countering unmanned aircraft systems (UASs). The system includes on-aircraft components and off-aircraft components. The on-aircraft components include a radio frequency takeover device, a mission computer, and an aircraft networking subsystem. The off-aircraft components include a command-and-control (02) subsystem and a ground networking subsystem. The aircraft networking subsystem and the ground networking subsystem are used to establish a data link, thereby enabling the transmission of data to and from the radio frequency takeover device and the 02 subsystem regarding potential UAS threats. This data may also be used to display information about potential UAS threats on the mission computer. If needed, operators on the ground can initiate a UAS mitigation procedure on the 02 subsystem to be carried out by the radio frequency takeover device aboard the aircraft.

### CROSS-REFERENCE TO RELATED APPLICATIONS

This application is a PCT patent application that makes a priority claim to U.S. Provisional Application No. 63/488,551 filed on Mar. 6, 2023, the disclosure of which is hereby incorporated by reference as if fully restated herein.

### FIELD

The application relates to systems and methods of countering unmanned aircraft and, more particularly, to systems and methods for protecting aircraft from unmanned aircraft by emulating the radio signals used to control the unmanned aircraft.

### BACKGROUND

Unmanned aircraft (or aerial) systems (UASs) (i.e., drones) are the subject of increasing adoption and proliferation. Across a diverse array of industries and at the consumer level there are new applications are being found for UASs. For example, UASs are now being used for applications such as search and rescue, surveillance, traffic monitoring, weather monitoring, firefighting, personal use, photography, videography, agriculture, and delivery services.

Those skilled in the art will appreciate, however, that UASs can and have been used by criminal organizations, foreign adversaries, and individuals for illicit activity as well. These illicit activities include, for example, contraband smuggling (e.g., drugs, weapons, etc.), trespassing, and spying. Accordingly, the ability to secure airspace at a location or surrounding an object and mitigate UASs (e.g., ward off, take control of, and/or destroy) is becoming increasingly important. To date, many so-called counter-UAS systems (C-UAS) have been developed to do just that.

### SUMMARY OF THE INVENTION

The present disclosure relates to a C-UAS for protecting aircraft, including while in flight. The C-UAS includes, among other things, several key components that are intended to be equipped onto an aircraft and operated therefrom. These components travel with the aircraft when the aircraft is flown. Due to this, the C-UAS is generally considered “airborne” and may be referred to as an “airborne C-UAS” (ACUS). Throughout this disclosure the C-UAS is simply referred to as the “system.”

Embodiments of the system generally include a radio frequency (RF) takeover device, a mission computer equipped with mission management software, an airborne networking subsystem, a control and command (C2) subsystem, and a ground networking subsystem. The RF takeover device, the mission computer, and the aircraft networking subsystem are provided on an aircraft. The C2 subsystem and the ground networking subsystem are provided off aircraft.

In some embodiments, the RF takeover device includes: a receiver and a transmitter; a spectrum analyzer configured to filter and amplify RF signals that are detectable proximate (at or near) an aircraft; a signal processor configured to demodulate and decode RF signals; and a radio frequency emulator configured to emulate the signal of a UAS controller and admit flight control parameters.

In some embodiments, the mission computer includes mission management software that is configured to render mapping information and augment the rendering with blended imagery or synthetic overlays to provide aircrew with UAS positional information.

In some embodiments, the aircraft networking subsystem includes: a network hub or switch operatively connected to the RF takeover device and the mission computer; and a modem/antenna configuration that supports data rates of at least 10 Mbps and is operable in the L band.

In some embodiments, the ground networking subsystem includes: a tracking antenna configured to track the location of the aircraft networking subsystem; a multichannel receiver and a diversity antenna controller operatively connected to the tracking antenna, the multichannel receiver and the diversity antenna controller being configured to support the simultaneous receipt of multiple RF signals across one or more channels; and transmitter that enables uplink data transmission to the aircraft networking subsystem.

In some embodiments, the C2 subsystem includes a network server operatively connected to the ground networking subsystem, the network server being configured to store data obtained by the RF takeover device; and mission software provided on the network server, the mission software being configured to reference and aggregate the data stored on the network server and to enable the initiation of a UAS mitigation procedure.

Other examples of the disclosed system will become apparent from the following detailed description, the accompanying drawings and the appended claims.

### BRIEF DESCRIPTION OF THE DRAWINGS

FIG. 1 is a system diagram of an exemplary embodiment of the airborne system for countering unmanned aircraft; and

FIG. 2 is an exemplary embodiment of an augmented rendering of mapping information on a GUI of a mission management software.

### DETAILED DESCRIPTION

The following detailed description refers to the accompanying drawings, which illustrate specific examples described by the disclosure. Other examples having different structures and operations do not depart from the scope of the present disclosure. Like reference numerals may refer to the same feature, element, or component in the different drawings.

Illustrative, non-exhaustive examples, which may be, but are not necessarily, claimed, of the subject matter according the present disclosure are provided below. Reference herein to “example” means that one or more feature, structure, element, component, characteristic and/or operational step described in connection with the example is included in at least one embodiment and/or implementation of the subject matter according to the present disclosure. Thus, the phrase “an example” and similar language throughout the present disclosure may, but do not necessarily, refer to the same example. Further, the subject matter characterizing any one example may, but does not necessarily, include the subject matter characterizing any other example.

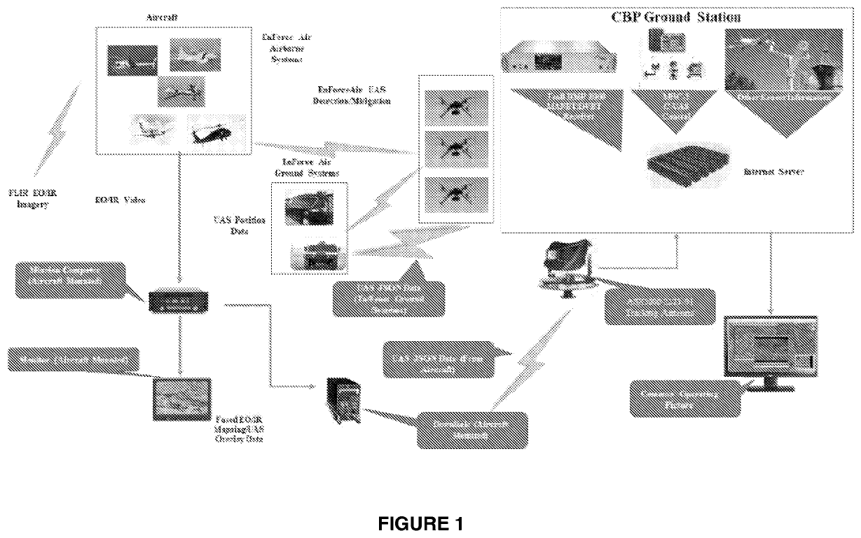

Referring to FIG. 1, the present disclosure relates to an airborne C-UAS (ACUS) (herein, the “system”) for detecting, tracking, identifying, and mitigating unamend aerial threats (i.e., UASs). In practice, the system may be utilized to control the airspace around an aircraft as a way of protecting the aircraft from UAS threats.

Considered broadly, the system includes on-aircraft (i.e., airborne) components and off-aircraft (i.e., ground) components. The on-aircraft components are intended to be mounted, equipped, or otherwise provided on an aircraft and will remain with the aircraft while in flight. The off-aircraft components are provided on the ground and communicate/operate with the on-aircraft components through a wireless data link.

Key on-aircraft components include a radio frequency (RF) takeover device, an aircraft networking subsystem, and a mission management software provided on a mission computer. The RF takeover device performs the detection and mitigation functions of the system. The mission management software aggregates data from various sensors involved in the system and presents that information to the aircraft crew. The aircraft networking subsystem establishes air-to-ground connectivity with the off-aircraft components.

Key off-aircraft components include a command-and-control subsystem (C2 subsystem) and a ground networking subsystem. The ground networking subsystem establishes ground-to-air connectivity with the on-aircraft components, namely, the aircraft networking subsystem. The C2 subsystem is the primary system interface for system operators on the ground and is used to: 1) store and access information generated by the various sensors involved in the system; and 2) receive system operator instructions/commands which may then be transmitted to the on-aircraft components via the ground networking subsystem.

The off-aircraft components are necessary to fully implement the capabilities of the on-aircraft components. Each of the key on-aircraft and off-aircraft components are described in turn below.

### Aircraft Considerations

The system is designed to meet the power and weight requirements of intermediate, medium and heavy helicopters (as classified by the FAA) and minimize electromagnetic interference (EMI) risks to susceptible aircraft components.

Intermediate, medium and heavy helicopters typically require that the total electrical load be less than 200 amps and less than 15 amps for individual avionics components.

Intermediate, medium and heavy helicopters typically require that avionics mission equipment be less than 50 lbs. Downposts (for antennas and cameras) are typically limited to avionics equipment that is less than 150 lbs.

Intermediate, medium and heavy helicopters typically require that avionics components do not produce, create, or cause any EMI that would affect and/or disrupt any navigation systems, flight controls (including autopilot), engine control units, or communications equipment (including distortion, bleedover, feedback or range reduction).

Intermediate, medium and heavy helicopters are currently being fielded by a variety of organizations including, but not limited to, the U.S. Department of Homeland Security and the Department of Defense.

### On-Aircraft Components

The RF takeover device includes sensors and/or cameras that enable it to scan and detect unique RF communication signals used by commercial and DIY UASs. The RF takeover device may include a spectrum analyzer for filtering and amplifying RF signals that are detectable proximate (at or near) an aircraft, thereby enabling system operators to discern the characteristics of said RF signals. The RF signals may then be correlated against known libraries of UASs to determine whether the signal is being transmitted by a UAS or its pilot. In preferred embodiments, the frequency range of the spectrum analyzer includes at least the 2.4 GHz, 5.8 GHZ, 433 MHz and 915 MHz frequency bands, which some UASs operate on. Further, the RF takeover device may also include a radio communication system for signal processing (demodulation, decoding, etc.), preferably broad-spectrum software defined radio (SDR). Digital signal processing (DSP) algorithms provided on an onboard computer may be used to translate the signal to obtain information about the UAS. In practice, this information will generally include one or more of the following: location information such as latitude, longitude, and altitude; inertial and orientation information such as aircraft velocity, pitch, roll, and yaw; the model of the UAS; the starting (home) location of the UAS; and the location of the pilot (collectively referred to as “precision data”). For some of this information—e.g., location, inertial, and orientation information-a record of past values at given points in time may be obtained as well that collectively represents the route taken by the UAS (referred to as “breadcrumbs” or “breadcrumbing”). This information can then be used by operators of the system to make informed decisions/determinations regarding the UAS's threat level and ultimately what a suitable mitigation strategy should be, if needed. This information can be displayed on an on-aircraft display though a mission management software (more on that below).

When a rogue UAS is detected, the RF takeover device may mitigate the potential treat by attempting to “takeover” the UAS. It does so by transmitting RF signals, by way of its own dedicated transmitter or a transmitter provided on the aircraft, that emulate the UAS controller's signal in order to admit flight control parameters (roll, pitch, and yaw). This enables the RF takeover device to “fend off” the UAS by moving the UAS away from the path of the protected aircraft, or by sending the UAS back to its controller, or by safely landing it in a predetermined location, thereby mitigating a potential threat and allowing it to be recovered. In exemplary embodiments, the RF takeover device may also identify the location of the rogue UAS pilot and display this information on aircraft monitors and the off-aircraft C2 subsystem.

In exemplary embodiments, the RF takeover device may be configured to perform the above-described functions passively and continuously.

In exemplary embodiments, the RF takeover device may be programmed to initiate mitigation in autonomous mode or manual mode. Preferably, the mitigation method (if more than one is enabled) would be selectable and capable of being triggered in either mode.

In exemplary embodiments, the RF takeover device may have an open architecture such that it is able to be integrated into other stand-alone components. This can include, for example, stand-alone sensors and cameras such as forward looking infra-red (FLIR) cameras (e.g., L3Harris Wescam), electro-optical/infra-red (EO/IR) sensors, and radars. This can also include stand-alone C-UAS technologies such as RF jammers and kinetic solutions. Stand-alone additions such as these may improve the overall mission capabilities of the system by enabling alternative mitigation and detection methods, providing redundancy, and by increasing the likelihood that precision data is determined from the UAS.

Examples of stand-alone additions that may be utilized with the system include the Skyview line of autonomous RF detection and tracking devices, available from BlueHalo LLC of San Diego, California. These devices may compliment the RF takedown device by supplementing or enhancing it's UAS detection and tracking capability as well as providing redundancy.

An example of a RF takeover device that is suitable for use with the system is the EnforceAir, available from D-Fend Solutions of Ra′anana, Israel. The EnforceAir is capable of mitigating many commercially available drones such as, but not limited to, the: DJI Phantom series, DJI Inspire series, DJI Matrice series, DJI Mavic series, Parrot Anafi, Parrot Anafi USA, Parrot Anafi Thermal, DJI Mini 2, DJI FPV, DJI Air 2S, Yuneec Mantis G, Yuneec Typhoon H, Yuneec Typhon H+, Yuneec Typhoon H3, Yuneec H520, DJI Mini SE, and DJI AGRAS Series. Another example of a RF takeover device that is suitable for use with the system is the Titan™ C-UAS system, available from BlueHalo LLC of San Diego, California. The Titan™ C-UAS system is capable of mitigating Group 1 & 2 drones, as classified by the U.S. Department of Defense. Group 1 drones weigh 20 lbs or less, have a nominal operating altitude of up to 1,200 feet above ground level, and are capable of speeds up to 100 knots. UASs such as the RQ-11 Raven, WASP, Puma, and PDW C100 are representative of Group 1 drones. Group 2 drones weigh between 21-55 lbs, have a nominal operating altitude of up to 3,500 feet above ground level, and are capable of speeds of up to 250 knots. UASs such as the ScanEagle, Flexrotor, SIC5 are representative of Group 2 drones.

The aircraft networking subsystem includes a network (e.g., ethernet) hub, switch, or similar type of device capable of connecting to the other on-aircraft components and making them act as a single network segment. The technical specifications of the ethernet hub may vary as needed to accommodate connectivity with the full array of on-aircraft system components for any given embodiment. Preferably, the ethernet hub may feature multiple high quality 4K, SDI inputs and outputs with HDMI monitoring standard.

The aircraft networking subsystem includes computing hardware (e.g., processors, memory, encoders, decoders, etc.) that enables it to process data from other on-aircraft components and serve as a data terminal. It can be utilized for performing functions such as, but not limited to, video encoding, decoding, encryption, DC power and data management. In exemplary embodiments, the computing hardware may also enable video stabilization, which when applied to sensor data can increase encoding speed and efficiency. Even more exemplary, the computing hardware may support various mapping protocols for purposes such as object detection, tracking, cursor-on-target (CoT), and map annotation.

The aircraft networking subsystem includes a modem/antenna configuration that enables uplink and downlink capabilities across multiple bands with the ability to control multiple channels of video and data. It is contemplated that this may provide redundancy, increased bandwidth, and improved quality and range to the ensuing data link. Moreover, this may also enable the aircraft networking subsystem to simultaneously transmit multiple data streams, which can be used to send video and sensor information such as gimbal inertial data used by an off-aircraft tracking antenna (more on that below) and UAS data generated by the RF takeover device (typically in JSON format).

The modem/antenna configuration may incorporate multiple transmitter (TX) and receiver (RX) antennas of various types. For example, the modem/antenna configuration may include bidirectional DVB-T transmitter and receiver pairs that operate in multiple bands from 1.2 GHz to 7 GHz. Additionally or alternatively, multiple-input and multiple-output (MIMO) transceivers can also be incorporated to establish simultaneous connectivity for tactical mesh networks. For the systems and intended applications disclosed herein, the modem/antenna configuration should at least support data rates of at least 10 Mbps, but preferably up to 40 Mbps. Moreover, the modem should be operable in the L band, between 1.2-2.0 Ghz.

The location of antenna(s) involved in the modem/antenna configuration on an aircraft may vary depending on the specifications of the aircraft and the antennas themselves. For fixed wing aircraft, the antenna(s) may be mounted on the fuselage. For rotary wing aircraft, the antenna(s) may be mounted to the front downpost. In exemplary embodiments, the system includes an omnidirectional antenna mounted on an aircraft downpost or panel antennas mounted to the exterior fuselage.

In exemplary embodiments, the computing hardware would include internal H.265 and/or H.264 encoders configured to route one or more transport streams to the off-aircraft components while simultaneous recording to a digital video recorder (DVR). Doing so allows mission exploitation to occur in real-time or playback from the aircraft with time delay. It is contemplated that this is particularly useful if reception becomes limited and bandwidth constrained. The DVR time delay ensures that air-to-ground video quality is maintained regardless of data link conditions onboard the aircraft.

In some embodiments, two or more of the components of the aircraft networking subsystem (described above) may be embodied in a single piece of hardware. An example of hardware that embodies all the aircraft networking subsystem components described above is the LinkBox II, available from Troll Systems Corporation of Santa Clarita, California.

The mission computer is a hardware component that can either be a stand-alone device or a device that is integrated into the aircraft itself. It includes processing hardware and circuitry that enable it to perform data processing functions. It also includes inputs and outputs (e.g., RS-232 inputs) that enable it to be integrated with the other on-aircraft system components (namely, but not limited to, the various on-aircraft sensors).

Peripheral to the mission computer is one or more monitors (i.e., electronic visual displays) that can be used to display useful information to the aircraft crew. Like the mission computer, it too can be a stand-alone device or a device that is integrated into the aircraft itself.

The mission management software is installed on the mission computer and, when executed, generates a GUI on an aircraft monitor. In exemplary embodiments, the GUI may be map-based, in that it renders mapping information regarding the surrounding area or areas of interest. Even more exemplary, the GUI may also provide augment reality capabilities relevant to the mapping information such as blended imagery and synthetic overlay. In practice, the fused information may provide aircrews with accurate UAS position information and thereby enhance situation awareness. Examples of mapping software that are suitable for use with the system include the ARS-600 or ARS-700, available from Shotover Systems of Boulder, Colorado. Currently, the DHS fields the ARS-600 in multiple aircraft. ARS-600 system weight is 5.91 lbs; ARS-700 system weight is 2.875 lbs. The ARS-700 is in STC (supplemental type certificate) development on the U.S. Customs and Border Protection H125 helicopter.

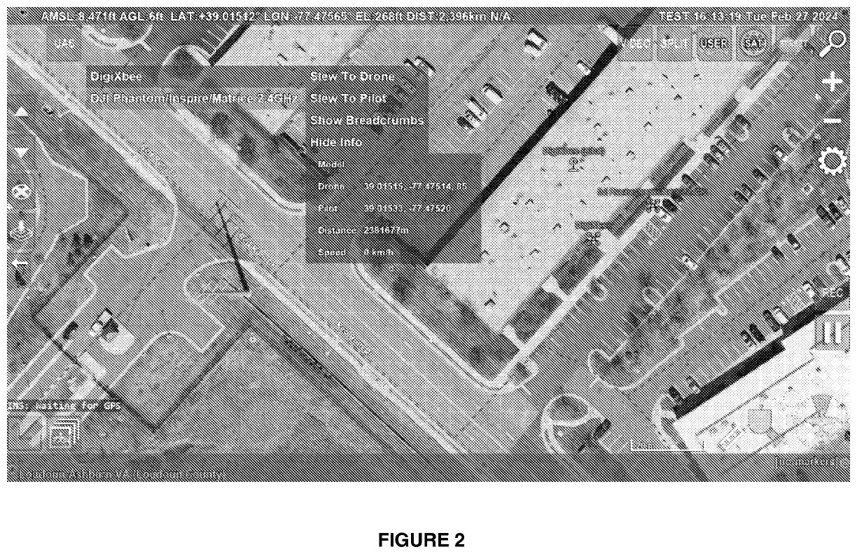

Shown in FIGS. 2-4 are examples of the Shotover mapping GUI that has been augmented using data obtained using a Skyview RF detection and tracking system. It is noted that icons representing two drones-labeled “DigiXbee” and “DJI Phantom/Insire/Matrice 2.4 GHz”—are overlayed on top of the map as well as an icon representing the DigiXbee pilot. It is also noted that there is an option to “Show Breadcrumbs” which, when selected, will overlay icons representing the previous locations of the two drones and/or pilot (provided that the information is available).

To ensure that the on-aircraft components are compatible with Intermediate, medium and heavy helicopters, it is imperative that the on-aircraft components meet certain power, weight, and EMI risk requirements.

Preferably, the RF takeover device would operate under power requirements between 12-36V and under 15 amps. Preferably, the RF takeover device would be lightweight (less than 100 lbs) and does not exceed the Aircraft Gross Weight limitations indicated in the Aircraft Flight Manual provided by the Federal Aviation Administration. Additionally, EMI produced by the system preferably would not cause interference with Aircraft Navigation, Flight, Engine or Communications systems while in passive or active mode.

If applicable, any on-aircraft components utilized in the system should have already been proven to be suitable for aircraft though DO-160 testing (as defined by the Radio Technical Commission for Aeronautics) and certified through the Federal Aviation Admiration (with a Supplemental Type Certificate).

### Off-Aircraft Components

The ground networking subsystem includes a tracking antenna configured to track the location of a moving signal source (namely, the aircraft networking subsystem) and use that information to correctly align a directional antenna, thereby potentially improving range and signal quality. In exemplary embodiments, this would be performed automatically based on a combination of inertial navigation data (e.g., from a gimbaled sensor) and global navigation satellite system (GNSS) data from one or more of the various on-aircraft components.

The ground networking subsystem includes a multichannel receiver and a remote site diversity antenna controller integrated with the tracking antenna. When operated in conjunction, these off-aircraft components may enable the simultaneous receipt of multiple RF signals across one or more channels (e.g., two to eight channel diversity mode or a one to four channel baseband). Ideally, these components would provide support for a variety of radio waveforms including, but not limited to, common data link (CDL), coded orthogonal frequency-division multiplexing (COFDM), orthogonal frequency-division multiplexing (OFDM), and frequency division duplex (FDD) (including MIMO/MANET and DVB-T).

The ground networking subsystem includes computing hardware (e.g., processors, memory, etc.) that enables data/signal processing functions such as, but not limited to, video decryption, encryption, video and audio decoding for local monitoring, and secure IP transport to remote C2 centers and for uplink to airborne platforms.

The ground networking subsystem includes a transmitter that enables uplink data transmission to the on-aircraft system components (namely, the aircraft networking subsystem). In practice, this can be used to enable system operators on the ground to issue instructions or commands as a way of exerting control over the on-aircraft components, including whether to initiate a mitigation function by the RF takeover device.

It is contemplated that two or more of the ground networking subsystem components described above may be embodied in a single piece of hardware. An example of such hardware that includes a tracking antenna and a transceiver is the AX3000, available from Troll Systems Corporation of Santa Clarita, California. An example of such hardware that includes a receiver and antenna controller is the DMR8000, available from Troll Systems Corporation of Santa Clarita, California.

In addition to the ground networking subsystem, the off-aircraft system components also include a C2 subsystem. The C2 subsystem includes a network (e.g., web) server operatively connected to the ground networking subsystem and mission software (preferably a web-based application installed on a web server). The information received by the ground networking subsystem (e.g., data, audio, video) (e.g., sensor data such as positional information and connectivity status) may be saved onto the network server and referenced by the mission software. The network server makes the saved information and the mission software accessible via a network (preferably an internet protocol network) from one or more permitted devices (e.g., computers, tablets, etc.).

The mission software may be launched from one or more permitted devices (via an appropriate web browser, e.g., Google Chrome) and, upon doing so, may generate a GUI on said devices that is configured to aggregate relevant information provided on the network server. In effect, the GUI may provide a unified, intuitive operational awareness to support mission-critical decisions. In exemplary embodiments, the mission software may be configured to eliminate duplications in the event multiple sensors detect the same UAS, instead presenting it as a single UAS event. Even more exemplary, the mission software may integrate with general map-based platforms and may fuse the sensor data with them. Even more exemplary, the mission software may provide the option to trigger UAS mitigation by the RF takeover device from a permitted device on the ground (via the antenna controller through the transmitter).

It is contemplated that two or more of the C2 subsystem components may be embodied in a single C2 solution. An example of such a C2 solution is the D-Fend Multi-Sensor Command & Control System (MSC2), available from D-Fend Solutions of Ra′anana, Israel.

As needed, the off-aircraft components of the system may also include one or more computers, tablets, or similar type of device capable of accessing the network server and launching the web-based application.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

1. An airborne system for countering UASs comprising:
a radio frequency (RF) takeover device provided on-aircraft, the RF takeover device comprising:
a receiver and a transmitter;
a spectrum analyzer for filtering and amplifying RF signals that are detectable proximate (at or near) an aircraft;
a signal processor for demodulating and decoding RF signals; and
a radio frequency emulator for emulating the signal of a UAS controller and admitting flight control parameters;
a mission computer provided on-aircraft, the mission computer comprising mission management software configured to render mapping information relevant to potential UAS threats;
an aircraft networking subsystem provided on-aircraft, the aircraft networking subsystem comprising:
a network hub or switch operatively connected to the RF takeover device and the mission computer; and
a modem/antenna configuration that supports data rates of at least 10 Mbps and is operable in the L band;
a ground networking subsystem provided off-aircraft, the ground networking subsystem comprising:
a tracking antenna for tracking the location of the aircraft networking subsystem;
a multichannel receiver and a diversity antenna controller operatively connected to the tracking antenna, the multichannel receiver and the diversity antenna controller being configured to support the simultaneous receipt of multiple RF signals across one or more channels; and
transmitter that enables uplink data transmission to the aircraft networking subsystem;
a command-and-control (C2) subsystem provided off-aircraft, the C2 subsystem comprising:
a network server operatively connected to the ground networking subsystem, the network server being configured to store and make accessible data obtained by the RF takeover device; and
mission software provided on the network server, the mission software being configured to reference and aggregate the data stored on the network server and initiation UAS mitigation procedures.

2. The system according to claim 1, wherein the RF takeover device is configured to detect and mitigate UASs autonomously.

3. The system according to claim 1, wherein the RF takeover device is configured to admit flight control parameters to a UAS that lands the UAS in a predetermined location.

4. The system according to claim 1, wherein the spectrum analyzer for the RF takeover device has a frequency range that includes at least 915 MHz to 2.4 GHz.

5. The system according to claim 1, wherein the total weight of the RF takeover device is less than 100 lbs.

6. The system according to claim 1, wherein the RF takeover device operates under power requirements between 12-36 volts and under 15 amps.

7. The system according to claim 1, further comprising a mission computer that comprises at least one of H.265 and H.264 encoders configured to route one or more transport streams to the ground networking subsystem while simultaneously recording to a digital video recorder.

8. The system according to claim 1, wherein the RF takeover device is configured to determine precision data from a radio signal controlling a UAS, the precision data comprising at least one of: latitude, longitude, altitude, velocity, pitch, roll, yaw, the model of the UAS, the home location of the UAS, and the location of the pilot.

9. The system according to claim 8, wherein the RF takeover device is configured to determine past precision data for a UAS.

10. The system according to claim 8, wherein the mission management software is configured to augment the rendering of mapping information with at least one of blended images and synthetic overlays.

11. The system according to claim 10, wherein the mission management software is configured to augment the rendering with icons representing the past or present locations of at least one of: a UAS and the pilot of a UAS.

12. The system according to claim 1, wherein the modem/antenna configuration comprises bidirectional DVB-T transmitter and receiver pairs that operate in multiple bands from 1.2 GHz to 7.0 GHz.

13. The system according to claim 1, wherein the modem/antenna configuration is configured to support waveforms including at least one of: common data link (CDL), coded orthogonal frequency-division multiplexing (COFDM), orthogonal frequency-division multiplexing (OFDM), and frequency division duplex (FDD) (including MIMO/MANET and DVB-T).

14. The system according to claim 1, wherein:
for fixed wing aircraft, the antenna of the modem/antenna configuration is mounted on the exterior of the fuselage; and
for rotary wing aircraft, the antenna of the modem/antenna configuration mounted on a front downpost.

15. The system according to claim 1, wherein the receiver of the ground networking subsystem is a multichannel receiver configured to support of simultaneous receipt of multiple RF signals across one or more channels.
